(19) United States
(12) Patent Application Publication
(10) Pub. No.: US 2022/0177718 A1
(43) Pub. Date: Jun. 9, 2022

(54) INK AND IMAGE FORMING METHOD

(71) Applicants: Kazuhiko Umemura, Kanagawa (JP); Sei Yamamoto, Tokyo (JP); Yuya Hirokawa, Kanagawa (JP); Hiroki Hagiwara, Kanagawa (JP); Takuya Saiga, Kanagawa (JP); Tomohiro Nakagawa, Kanagawa (JP)

(72) Inventors: Kazuhiko Umemura, Kanagawa (JP); Sei Yamamoto, Tokyo (JP); Yuya Hirokawa, Kanagawa (JP); Hiroki Hagiwara, Kanagawa (JP); Takuya Saiga, Kanagawa (JP); Tomohiro Nakagawa, Kanagawa (JP)

(73) Assignee: Ricoh Company, Ltd., Tokyo (JP)

(21) Appl. No.: 17/457,690

(22) Filed: Dec. 6, 2021

(30) Foreign Application Priority Data
Dec. 9, 2020 (JP) 2020-204077

(51) Int. Cl. C09D 11/033; C09D 11/322; C09D 11/037; C09D 11/102; C09D 11/107; B41M 5/00

(52) U.S. Cl. CPC C09D 11/033; C09D 11/322; B41M 5/0023; C09D 11/102; C09D 11/107; C09D 11/037

(57) ABSTRACT

An ink contains organic solvents containing 1,2-propane diol and 1,2-hexane diol, a pigment, water, and a polyoxyethylene ether compound.

### CROSS-REFERENCE TO RELATED APPLICATIONS

This patent application is based on and claims priority pursuant to 35 U.S.C. § 119 to Japanese Patent Application No. 2020-204077 filed on Dec. 9, 2020 in the Japan Patent Office, the entire disclosure of which is hereby incorporated by reference herein.

### BACKGROUND

### Technical Field

The present disclosure relates to an ink and an image forming method.

### Description of the Related Art

Inkjet printing is simple and readily realizes full colorization in comparison with other printing methods. Even a simple inkjet device can create high resolution images. For this reason, inkjet printing is now widely applied for office, industrial, or commercial as well as home settings.

In the commercial settings, recording media including coated paper, art paper, and polymer film such as polyethylene terephthalate (PET) and oriented polypropylene (OPP) for soft packaging are used in addition to plain paper. Printed matter is used as products such as postcards and packages.

When forming an image on a poorly absorbable substrate such as coated paper and polymer film with aqueous ink, so-called beading is likely to occur.

### SUMMARY

According to embodiments of the present disclosure, an ink is provided which contains organic solvents containing 1,2-propane diol and 1,2-hexane diol, a pigment, water, and a polyoxyethylene ether compound.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a perspective view of an example of an inkjet printing device;

FIG. 2 is a diagram illustrating a perspective view of an example of a tank of an inkjet printing device; and

FIG. 3 is a diagram illustrating a printing device and a printing method suitably applicable to the present disclosure.

The accompanying drawings are intended to depict example embodiments of the present invention and should not be interpreted to limit the scope thereof. The accompanying drawings are not to be considered as drawn to scale unless explicitly noted.

Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an.” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

Inkjetting is required to have good discharging stability to minimize print downtime and achieve high productivity. Inkjet ink is necessary to have abrasion resistance. Such ink tends to adhere to a recording head, which degrades the discharging stability. Striking a balance between the discharging stability and the abrasion resistance is a problem in this field.

According to the present disclosure, an ink is provided which minimizes beading when images are created on poorly absorbable substrate such as coated paper and polymer film and strikes a balance between continuous discharging stability and abrasion resistance.

Embodiments of the present disclosure are described in detail below.

The ink of the present disclosure contains organic solvents, a pigment, water, and a polyoxyethylene ether compound. The organic solvents contain 1,2-propane diol and 1,2-hexane diol.

This combination of the organic solvents and the polyoxyethylene ether compound prevents beading when images are created on poorly absorbable substrate such as coated paper and polymer film and achieves a high level of continuous discharging stability and abrasion resistance.

1,2-hexane diol has relatively low water retention and is likely to volatilize the moisture in ink. For this reason, this compound quickly volatilizes the moisture in ink droplets that have reached a poorly absorbable substrate and prevents uneven distribution and agglomeration of the pigment contained in ink. At the same time, 1,2-hexane diol has a high boiling point and is unlikely to volatilize, which prevents the pigment in ink from flowing, being unevenly distributed, and agglomerating.

On the other hand, 1,2-propane diol has a relatively high water retention. This compound thus prevents ink discharging defects and nozzle clogging caused by ink dried in nozzles for inkjetting because the moisture in the ink volatilizes around the nozzles.

The proportion of 1,2-hexane diol in the entire ink is preferably from 5 to 20 percent by mass and more preferably from 7 to 13 percent by mass. In this range, beading is further reduced and discharging defects are prevented.

The proportion of 1,2-propane diol in the entire ink is preferably from 5 to 30 percent by mass and more preferably from 7 to 25 percent by mass. In this range, beading is further reduced and discharging defects are prevented.

The polyoxyethylene ether compound strikes a balance between minimizing beading and preventing discharging defects at a high level by a combinational use with the organic solvent mentioned above.

Since the polyoxyethylene ether compound is well dissolved in ink, the present inventors infer that the polyoxyethylene ether compound is present on the outermost surface of an ink droplet just when the droplet reaches a polyoxyethylene ether compound, which accelerates the coverage by the droplet. The present inventors also infer that the polyoxyethylene ether compound present on the surface of ink around a nozzle facilitates forming a meniscus of ink, which leads to improvement on the discharging stability.

The proportion of the polyoxyethylene ether compound in the entire ink is preferably from 0.05 to 2.0 percent by mass and more preferably from 0.5 to 1.5 percent by mass. In this range, beading is further reduced and discharging defects are prevented.

The polyoxyethylene ether compound is represented by RO(C₂H₄O)ₙH. In this Chemical formula, R is an alkyl group and a preferable number of carbon atoms is from 10 to 18. “n” is a repeated number of from, for example, 2 to 10.

Of these, the polyoxyethylene ether compound in the present disclosure includes polyoxyethylene glycol trimethyl nonyl ether (Cas. No. 60828-78-6, also known as poly(oxyethylene ether)=3,5-dimethyl-1-(2-methylpropyl)hexyl=ether). The usage of this compound makes the present disclosure more effective.

Specific procurable products of the polyoxyethylene glycol trimethyl nonyl ether include, but are not limited to, TRITON HW-1000 of the Dow Chemical Company and Tergitol TMN6, TMN10 and TMN-3 of Sigma-Aldrich Co. LLC.

The ink of the present disclosure preferably contains at least one of urethane resin and acrylic resin, i.e., urethane resin and/or acrylic resin, to enhance the abrasion resistance.

These resins form a film on and attaches to a substrate and fix the pigment in ink.

It is generally preferable to use urethane resin to enhance the abrasion resistance depending on a particular application. However, urethane resin is inferior in the drying property. The combinational use with acrylic resin enhances the handling property of ink and the adaptability of types of substrates. Urethane resin and/or acrylic resin are preferably resin particles and more preferably resin emulsion. Water-soluble resin tends to increase the viscosity of ink and change the temperature properties; however, resin in emulsion minimizes the change in properties.

It is possible to mix a resin emulsion in which such resin particles are dispersed in water as a dispersion medium with an organic solvent and materials such as a coloring material to obtain an ink. It is possible to use synthetic or procurable resin particles as the resin particle.

Of these, polycarbonate urethane resin is preferable in terms of abrasion resistance and fixability. Specific examples of the polycarbonate urethane resins include, but are not limited to, TAKELAC™ WS-4000, W-6010, and W6110, and UCOAT series of DKS Co., Ltd.

Specific examples of the acrylic resin include, but are not limited to, acrylic resin, vinyl acetate resin, styrene resin, styrene-butadiene resin, butadiene resin, vinyl chloride resin, and acrylic-styrene resin.

These resins preferably polymers having both a hydrophilic portion and a hydrophobic portion.

Specific examples of procurable resin emulsions include, but are not limited to, microjel E-1002 and E-5002 (styrene-acrylic resin, manufactured by NIPPONPAINT Co., Ltd.), VONCOAT 400 and 4001 (acrylic resin emulsion, manufactured by DIC Corporation). VONCOAT 5454 (styrene-acrylic resin emulsion, manufactured by DIC Corporation), SAE-1014 (styrene-acrylic resin emulsion, manufactured by Zeon Corporation), and Saivinol SK-200 (acrylic resin emulsion, manufactured by Saiden Chemical Industry Co., Ltd.).

The mean volume diameter (volume average particle diameter) of the resin particle is not particularly limited and can be suitably selected to suit to a particular application. The volume average particle diameter is preferably from 10 to 1,000 nm, more preferably from 10 to 200 nm, and particularly preferably from 10 to 100 nm to achieve good fixability and image robustness.

The proportion of the resin is not particularly limited and can be suitably selected to suit to a particular application. It is preferably from 1 to 30 percent by mass and more preferably from 5 to 20 percent by mass of the entire ink to secure fixability and abrasion resistance at a high level.

The ink of the present disclosure may optionally contain the materials below in addition to the materials mentioned above.

Organic Solvent

There is no specific limitation to the organic solvent for use in the present disclosure. For example, a water-soluble organic solvent can be used. It includes, but are not limited to, polyhydric alcohols, ethers such as polyhydric alcohol alkylethers and polyhydric alcohol arylethers, nitrogen-containing heterocyclic compounds, amides, amines, and sulfur-containing compounds.

Specific examples of the water-soluble organic solvents include, but are not limited to, polyhydric alcohols such as ethylene glycol, diethylene glycol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutyl ether, diethylene glycol monomethylether, diethylene glycol monoethylether, diethylene glycol monobutyl ether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propionamide, and 3-butoxy-N,N-dimethyl propionamide; amines such as monoethanolamine, diethanolamine, and triethylamine; sulfur-containing compounds such as dimethyl sulfoxide, sulfolane, and thiodiethanol; propylene carbonate, and ethylene carbonate.

It is preferable to use an organic solvent having a boiling point of 250 or lower degrees C., which serves as a humectant and imparts a good drying property at the same time.

The proportion of the organic solvent in ink has no particular limit and can be suitably selected to suit to a particular application.

In terms of drying and discharging reliability of the ink, the proportion is preferably from 10 to 60 percent by mass and more preferably from 20 to 60 percent by mass.

The proportion of water in ink is not particularly limited and can be suitably selected to suit to a particular application; it is preferably from 10 to 90 percent by mass and more preferably from 20 to 60 percent by mass to enhance the drying property and discharging reliability of the ink.

The pigment may include an inorganic pigment or organic pigment. These can be used alone or in combination. In addition, a mixed crystal can also be used as the coloring material.

Examples of the pigments include, but are not limited to, black pigments, yellow pigments, magenta pigments, cyan pigments, white pigments, green pigments, orange pigments, and gloss or metallic pigments of gold, silver, and others.

Carbon black manufactured by known methods such as contact methods, furnace methods, and thermal methods can be used as the inorganic pigment in addition to titanium oxide, iron oxide, calcium carbonate, barium sulfate, aluminum hydroxide, barium yellow, cadmium red, and chrome yellow.

Specific examples of the organic pigment include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of those pigments, pigments having good affinity with solvents are preferable. Hollow resin particles and hollow inorganic particles can also be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51. C.I. Pigment Red 1, 2, 3, 5, 17, 22, 23, 31, 38, 48:2, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63, C.I. Pigment Green 1, 4, 7, 8, 10, 17, 18, and 36.

A dye can be optionally added.

The dye is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in ink is preferably from 0.1 to 15 percent by mass and more preferably from 1 to 10 percent by mass to enhance the image density, fixability, and discharging stability.

Pigment-dispersed ink is obtained by, for example, preparing a self-dispersible pigment through an introduction of a hydrophilic functional group into a pigment, coating the surface of a pigment with a resin followed by dispersion, or using a dispersant to disperse a pigment.

One way of preparing a self-dispersible pigment by introducing a hydrophilic functional group into a pigment is to add a functional group such as a sulfone group and carboxyl group to a pigment (e.g., carbon) to disperse the pigment in water.

One way of dispersing a resin by coating the surface thereof is to encapsulate a pigment in a microcapsule to make it disperse in water. This can be referred to as a resin-coated pigment. In this case, all the pigments to be added to ink are not necessarily entirely coated with resin. Pigments not partially or wholly covered with resin are allowed to be dispersed in the ink unless such pigments have an adverse impact.

A known dispersant of a small or large molecular weight, which is represented by a surfactant, can be used to disperse the coloring material in ink.

It is possible to select an anionic surfactant, a cationic surfactant, a nonionic surfactant, an amphoteric surfactant, or others depending on a pigment.

Also, a nonionic surfactant (RT-100, manufactured by TAKEMOTO OIL & FAT CO., LTD.) and a formalin condensate of naphthalene sodium sulfonate are suitable as the dispersant.

Those can be used alone or in combination.

Pigment Dispersion

Ink can be obtained by mixing a pigment with materials such as water and an organic solvent. It is also possible to manufacture ink by mixing a pigment with water, a dispersant, and other substances to prepare a pigment dispersion and thereafter mix the pigment dispersion with materials such as water and an organic solvent.

The pigment dispersion is obtained by mixing and dispersing water, a pigment, a pigment dispersant, and other optional components followed by the particle size adjustment. It is good to use a dispersing device for dispersion.

The particle diameter of the pigment in the pigment dispersion has no particular limit. For example, the maximum frequency is preferably from 20 to 500 nm and more preferably from 20 to 150 nm in the maximum number conversion to improve dispersion stability of the pigment and ameliorate discharging stability and the image quality such as image density. The particle diameter of the pigment can be analyzed using a particle size analyzer (Nanotrac Wave-UT151, manufactured by MicrotracBEL Corp).

The proportion of the pigment in the pigment dispersion is not particularly limited and can be suitably selected to suit a particular application. In terms of improving discharging stability and image density, the proportion is preferably from 0.1 to 50 percent by mass and more preferably from 0.1 to 30 percent by mass.

It is preferable that the pigment dispersion be filtered with an instrument such as filter and a centrifuge to remove coarse particles followed by deaerating.

The volume average particle diameter of the resin particle is not particularly limited and can be suitably selected to suit to a particular application. The volume average particle diameter is preferably from 10 to 1,000 nm, more preferably from 10 to 200 nm, and particularly preferably from 10 to 100 nm to achieve good fixability and image robustness.

The volume average particle diameter can be measured by using a device such as a particle size analyzer (Nanotrac Wave-UT151, manufactured by MicrotracBEL Corp.).

The proportion of the resin is not particularly limited and can be suitably selected to suit to a particular application. It is preferably from 1 to 30 percent by mass and more preferably from 5 to 20 percent by mass of the total mass of the ink to secure fixability and storage stability of an entire ink.

The particle diameter of the solid portion in the ink has no particular limit and can be suitably selected to suit to a particular application. For example, the maximum frequency in the maximum number conversion is preferably from 20 to 1,000 nm and more preferably from 20 to 150 nm to ameliorate the discharging stability and image quality such as optical density.

The solid content includes resin particles and particles of pigment. The particle diameter can be measured by using a particle size analyzer (Nanotrac Wave-UT151, manufactured by MicrotracBEL Corp).

Additive The ink may further optionally include additives such as a surfactant, defoaming agent, preservative and fungicide, corrosion inhibitor, and pH regulator.

A surfactant is optionally added in the present disclosure.

Surfactant

Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application.

Of these, surfactants not decomposable in a high pH environment are preferable. Examples of the silicone-based surfactants include, but are not limited to, side chain modified polydimethyl siloxane, both terminal-modified polydimethyl siloxane, one-terminal-modified polydimethyl siloxane, and side-chain-both-terminal-modified polydimethyl siloxane. In particular, silicone-based surfactants having a polyoxyethylene group or a polyoxyethylene polyoxypropylene group as a modification group are particularly preferable because such an aqueous surfactant demonstrates good properties. The silicone-based surfactant includes a polyether-modified silicone-based surfactant. A specific example is a compound in which a polyalkylene oxide structure is introduced into the side chain of the Si site of dimethyl siloxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams. Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carbonic acid compounds include, but are not limited to, perfluoroalkyl carbonic acid and salts of perfluoroalkyl carbonic acid.

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K. NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactant has no particular limit and can be suitably selected to suit to a particular application.

Specific examples include, but are not limited to, side-chain-modified polydimethyl siloxane, both terminal-modified polydimethyl siloxane, one-terminal-modified polydimethyl siloxane, and side chain both-terminal-modified polydimethyl siloxane. Of these, a polyether-modified silicone-based surfactant having a polyoxyethylene group or a polyoxyethylene polyoxypropylene group is particularly preferable because such a surfactant demonstrates good property as the aqueous surfactant.

Such surfactants can be synthesized or procured. Products can be procured from BYK-Chemie GmbH, Shin-Etsu Silicone Co., Ltd., Dow Corning Toray Co., Ltd., NIHON EMULSION Co., Ltd., Kyoeisha Chemical Co., Ltd., and others.

Specific examples of the polyether-modified silicone-based surfactant include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Chemie GmbH), and TSF4440, TSF4452, and TSF4453 (all manufactured by GE Toshiba Silicone Co. Ltd.).

A fluorochemical surfactant in which the number of carbon atoms replaced with fluorine atoms is 2 to 16 is preferable and, 4 to 16, more preferable.

The fluorochemical surfactant is commercially available. Specific examples include, but are not limited to, SURFLON S-111, S-112. S-113, S-121, S-131, S-132, S-141, and S-145 (all manufactured by ASAHI GLASS CO., LTD.); FLUORAD FC-93, FC-95, FC-98, FC-129, FC-135, FC-170C, FC-430, and FC-431 (all manufactured by Sumitomo 3M Limited): MEGAFACE F-470. F-1405, and F-474 (all manufactured by DIC CORPORATION); ZONYL TBS, FSP, FSA, FSN-100, FSN, FSO-100, FSO, FS-300, UR, and Capstonem FS-30. FS-31, FS-3100, FS-34, and FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.); and UNIDYNE™ DSN-403N (manufactured by DAIKIN INDUSTRIES, Ltd.). Of these, in terms of improvement on print quality, in particular coloring property and permeability, wettability, and uniform dying property on paper, FS-3100, FS-34, and FS-300 of The Chemours Company, FT-110, FT-250, FT-251, FT-400S, FT-150, and FT-400SW of NEOS COMPANY LIMITED, POLYFOX PF-151N of OMNOVA SOLUTIONS INC., and UNIDYNE™ DSN-403N (manufactured by DAIKIN INDUSTRIES, Ltd.) are particularly preferable.

Defoaming Agent

The defoaming agent has no particular limit. Examples include, but are not limited to silicon-based defoaming agents, polyether-based defoaming agents, and aliphatic acid ester-based defoaming agents. These can be used alone or in combination. Of these, silicone-based defoaming agents are preferable to achieve the effect of foam breaking.

Preservatives and Fungicides

The preservatives and fungicides are not particularly limited. A specific example is 1,2-benzisothiazoline-3-one.

Corrosion Inhibitor

The corrosion inhibitor has no particular limitation. Specific examples include, but are not limited to, acid sulfites and sodium thiosulfates.

pH Regulator

The pH regulator has no particular limit as long as it can control pH to be not lower than 7.

Specific examples include, but are not limited to, amines such as diethanol amine and triethanol amine.

Properties of the ink are not particularly limited and can be suitably selected to suit to a particular application; viscosity, surface tension, and pH are preferable in the following ranges.

The ink preferably has a viscosity of from 5 to 30 mPa-s and more preferably from 5 to 25 mPa-s at 25 degrees C. to enhance the print density and text quality and achieve a good dischargibility. Viscosity can be measured by equipment such as a rotatory viscometer (RE-80L, manufactured by TOKI SANGYO CO., LTD.). The measuring conditions areas follows:
Standard cone rotor (1°34′×R24)
Sample liquid amount; 1.2 mL
Rate of rotation: 50 rotations per minute (rpm)
25 degrees C.
Measuring time: three minutes.

The surface tension of the ink is preferably 35 mN/m or less and more preferably 32 mN/m or less at 25 degrees C. because the ink suitably levels on a recording medium and the ink dries in a shorter time.

pH of the ink is preferably from 7 to 12 and more preferably from 8 to 11 to prevent corrosion of metal material in contact with liquid.

The image forming method of the present disclosure includes applying a processing fluid containing flocculant to a recording medium and inkjetting the ink mentioned above to the recording medium on which the processing fluid has been applied to form an image.

Processing Fluid

The pre-processing fluid includes a flocculant, an organic solvent, water, and optional materials such as a surfactant, a defoaming agent, a pH regulator, a preservatives and fungicides, and a corrosion inhibitor.

The organic solvent, the surfactant, the defoaming agent, the pH regulator, the preservatives and fungicides, and the corrosion inhibitor can be the same material as those for use in ink. Other material for use in known processing fluid can be used.

The type of the flocculant is not particularly limited. For example, water-soluble cationic polymers, acids, and multi-valent metal salts are suitable.

The proportion of a flocculant is preferably from 10 to 30 percent by mass.

Post-Processing Fluid

The post-processing fluid has no particular limit. It is preferable that the post-processing fluid can form a transparent layer. Material such as organic solvents, water, resins, surfactants, defoaming agents, pH regulators, preservatives and fungicides, corrosion inhibitors, etc. is suitably selected based on a necessity basis and mixed to obtain the post-processing fluid. The post-processing fluid can be applied to the entire recording area formed on a recording medium or only the area on which an ink image is formed.

Processing Fluid Application and Processing Fluid Application Device

The application of the processing fluid includes applying the processing fluid to a recording medium and is executed by a processing fluid application device.

The surface of a non-permeating substrate such as polyethylene terephthalate is allowed to be subjected to corona treatment by an electroconductive roller or plasma before a processing fluid is applied. In general, corona treatment increases the hydrophilicity of an organic material and enhances the wettability and application uniformity of aqueous liquid.

There is no specific limit to the method of applying the processing fluid and it can be suitably selected to suit to a particular application.

Specific examples include, but are not limited, an inkjet printing method, a blade coating method, a gravure coating method, a gravure offset coating method, a bar coating method, a roll coating method, a spray coating method, a knife coating method, an air knife coating method, a comma coating method, a U comma coating method, an AKKU coating method, a smoothing coating method, a microgravure coating method, a reverse roll coating method, a four or five roll coating method, a dip coating method, a curtain coating method, a slide coating method, and a die coating method.

Of these, a roll coating method and a spray coating method are preferable.

A substrate to which a processing fluid has been applied is optionally heated to dry the processing fluid. The substrate is heated by a known heating device such as a roll heater, drum heater, and heated wind to dry the processing fluid applied to the substrate.

Ink Application and Ink Application Device

The ink application is to apply the ink of the present disclosure and executed by an ink application device.

In the present disclosure, the ink is preferably applied by inkjetting.

Recording Device and Recording Method

The ink of the present disclosure can be suitably applied to various recording devices employing an inkjet recording method, such as printers, facsimile machines, photocopiers, multifunction peripherals (serving as a printer, a facsimile machine, and a photocopier), and solid freeform fabrication devices such as 3D printers and additive manufacturing devices.

In the present disclosure, the recording device and the recording method respectively represent a device capable of discharging ink and liquids such as various processing fluids to a recording medium and a method of recording utilizing such a device. The recording medium means an item to which ink or various processing fluids can be temporarily or permanently attached.

The recording device may furthermore optionally include a device relating to feeding, conveying, and ejecting a recording medium and other devices referred to as a pre-processing device and a post-processing device in addition to the head portion for discharging the ink.

The recording device and the recording method may further optionally include a heating device (heater) for use in the heating and a drying device (drier) for use in the drying. For example, the heating device and the drying device heat and dry the print surface and the opposite surface of a recording medium. The heating device and the drying device are not particularly limited. For example, a fan heater and an infra-red heater can be used. Heating and drying can be conducted before, in the middle of, or after printing.

In addition, the recording device and the recording method are not limited to those producing meaningful visible images such as text and figures with ink. For example, the recording method and the recording device capable of producing patterns like geometric design and 3D images are included.

In addition, the recording device includes both a serial type device in which the discharging head moves and a line type device in which the discharging head is not moved, unless otherwise specified.

Furthermore, in addition to the desktop type, this recording device includes a device capable of printing images on a wide recording medium having, for example, AO size, and a continuous printer capable of using continuous paper rolled up in a roll-like form as a recording medium.

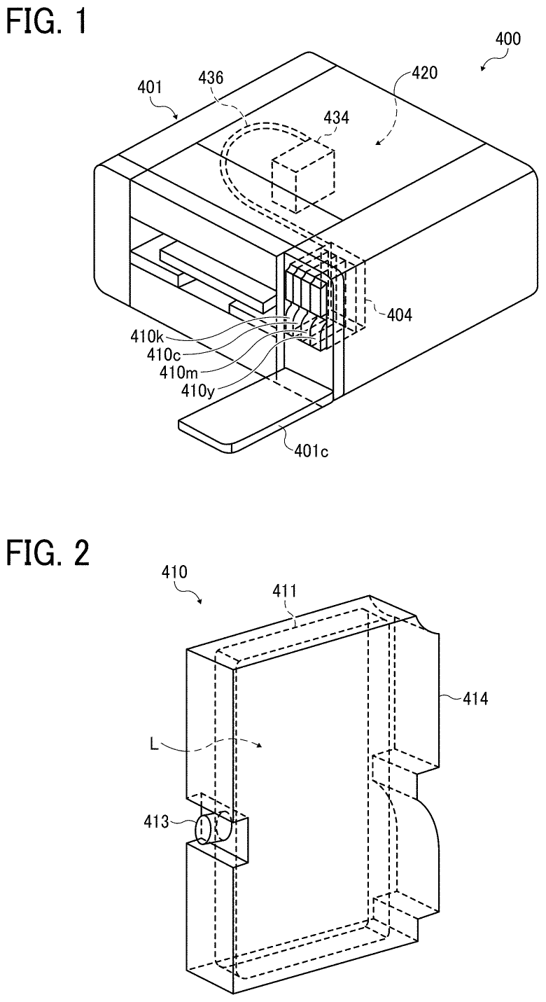

The recording device is described using an example with reference to FIG. 1 and FIG. 2. FIG. 1 is a diagram illustrating a perspective view of the same device. FIG. 2 is a diagram illustrating a perspective view of a tank. An image forming apparatus 400 as an embodiment of the recording device is a serial type image forming apparatus. A mechanical unit 420 is disposed in an exterior 401 of the image forming apparatus 400. Each ink accommodating unit (ink container) 411 of each tank 410 (410k, 410c, 410m, and 410y) for each color of black (K), cyan (C), magenta (M), and yellow (Y) is made of a packaging member such as aluminum laminate film. The ink accommodating unit 411 is housed in, for example, a plastic container housing unit 414 and L represents liquid contained in the ink accommodating unit 411.

As a result, the tank 410 is used as an ink cartridge of each color.

A cartridge holder 404 is disposed on the rear side of the opening appearing when a cover 401c is opened. The tank 410 is detachably attached to the cartridge holder 404. In this configuration, each ink discharging outlet 413 of the tank 410 communicates with a discharging head 434 for each color via a supplying tube 436 for each color and the ink can be discharged from the discharging head 434 to a recording medium.

This recording device may include not only a portion for discharging ink but also a device referred to as a pre-processing device and a post-processing device.

As an example of the pre-processing device and the post-processing device, like the ink of black (K), cyan (C), magenta (M), and yellow (Y) ink, the pre-processing device and the post-processing device may further include a liquid accommodating unit including a pre-processing liquid or a post-processing liquid and a liquid discharging head to discharge the pre-processing liquid or the post-processing liquid according to an inkjet printing method.

As another example of the pre-processing device and the post-processing device, it is suitable to dispose a pre-processing device and a post-processing device not employing the inkjet printing method but a blade coating method, a roll coating method, or a spray coating method.

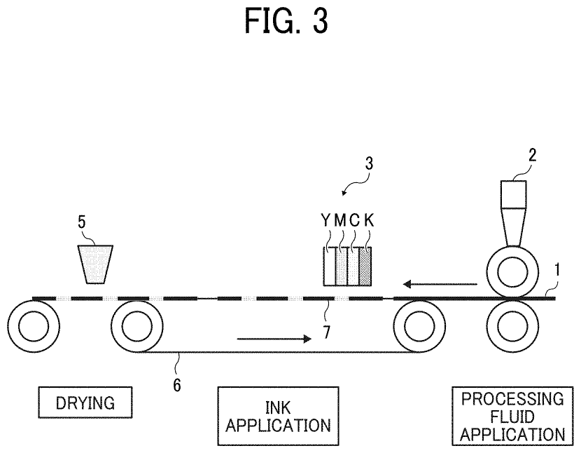

FIG. 3 is a diagram illustrating a printing device and a printing method suitably applicable to the present disclosure.

The printing device illustrated in FIG. 3 includes a processing fluid applying device 2 for applying a processing fluid, an ink discharging head 3 for discharging black ink (K), cyan ink (C), magenta ink (M), yellow ink (Y), a drying device 5, and a conveyor belt 6 for conveying a recording medium or substrate 1.

The printing method includes applying a processing fluid to the substrate 1, applying ink to the substrate 1 by the ink discharging head 3 to form a print portion 7, and drying the substrate 1 after the ink application.

The printing device and the printing method may further optionally include a heating device (heater) for use in the heating and a drying device (drier) for use in the drying. The heating device and the drying device may optionally heat and dry the print surface and the opposite surface of a substrate. The heating device and the drying device are not particularly limited. For example, a fan heater and an infra-red heater can be used. Heating and drying can be conducted before, in the middle of, or after printing.

In addition, the printing device and the printing method are not limited to those producing meaningful visible images such as text and figures with ink. For example, the printing method and the printing device capable of producing patterns like geometric design and 3D images are included.

In addition, the printing device includes both a serial type device in which the discharging head moves and a line type device in which the discharging head is not moved, unless otherwise specified.

Furthermore, in addition to the desktop type, this printing device includes a device capable of printing images on a substrate having a large size such as AO size, and a continuous printer capable of using continuous paper rolled up in a roll-like form as a substrate.

Examples of the poorly absorbable substrate include, but are not limited to, polypropylene film, polyethylene terephthalate film, and nylon film.

Specific examples of the polypropylene film include, but are not limited to, P-2002, P-2161, P-4166, all manufactured by TOYOBO CO., LTD., PA-20, PA-30, and PA-20W, all manufactured by SUNTOX Co., Ltd., and FOA, FOS, and FOR, all manufactured by FUTAMURA CHEMICAL CO., LTD.

Specific examples of the polyethylene terephthalate film include, but are not limited to, E-5100 and E-5102, both manufactured by TOYOBO CO., LTD., P60 and P375, both manufactured by Toray Industries, Inc., and G2, G2P2, K. and SL, all manufactured by Teijin Dupont Film Japan Limited.

Specific examples of the nylon film include, but are not limited to, HARDEN film N-1100, N-1102, and N-1200, all manufactured by TOYOBO CO., LTD., and ON, NX, MS, and NK, all manufactured by UNITIKA LTD.

Coated paper is also included.

Specific examples include, OK-TOP coat of Oi PAPER CO., LTD. and colored liner for corrugate.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto. Examples and Comparative Example were prepared and evaluated at 25 degrees C. and humidity of 60 percent unless otherwise specified. In Examples, part means part by mass.

### Preparation Example 1 of Pigment Dispersion

Preparation of Dispersant-Dispersed Magenta Pigment Dispersion

A mixture of 100 g of carbon black (Black Pearl Is 1000, manufactured by Cabot Corporation), 15 g of a condensation product of naphthalene sulfonic acid and formalin naphthalene (Pionin A-45-PN, manufactured by TAKEMOTO OIL & FAT CO., LTD.), and 280 g of deionized water was premixed followed by dispersing with DYNO-MILL (manufactured by Shinmaru Enterprises Corporation) at a rate of rotation of 10 m/sec and 10 degrees C. for 30 minutes using zirconia beads having a particle diameter of 0.3 mm to obtain a pigment dispersion.

The pigment dispersion thus obtained was separated from the zirconia beads followed by filtering with a membrane filter (cellulose acetate type) having an average pore diameter of 0.8 μm. Thereafter, the moisture in the resulting matter was adjusted in such a manner that the solid content was 20 percent by mass to obtain a dispersant-dispersed black pigment dispersion.

Ink was prescribed according to the formulation (percent by mass) shown in Table 1. The raw material of ink was placed in a 1 litter beaker followed by sufficient stirring and filtering with a filter.

TABLE 1

| | | | Example | | | |
|---|---|---|---|---|---|---|
| Component and product name | | | 1 | 2 | 3 | 4 |
| Solvent | 1,2-hexanediol | | 10 | 10 | 10 | 10 |
| | 1,2-propane diol | | 10 | 10 | 10 | 10 |
| | 1,2-butane diol | | | | | |
| | 1,3-butane diol | | | | | |
| Black | Black pigment | | 15 | 15 | 15 | 15 |
| pigment | dispersion | | | | | |
| dispersion | (Pigment solids | | | | | |
| | content: 20 | | | | | |
| | percent by mass) | | | | | |
| Surfactant | Polyethylene glycol | HW-1000 | 0.5 | 0.5 | 0.5 | 0.5 |
| | trimethylnonyl ether | TMN-10 | | | | |
| | Acetylene glycol- | Surfynol 440 | | | | |
| | based | | | | | |
| | Polysiloxane-based | BYK-345 | | | | |
| Resin | Urethane resin | WS-6021 | | 15 | 0 | 8 |
| particle | | SUPERFLEX ® | | | | |
| | | 460S | | | | |
| | Acrylic resin | VONCOAT | | 0 | 10 | 5 |
| | | 400 | | | | |
| | | TOCRYL ™ | | | | |
| | | W463 | | | | |
| Water | Distilled water | | Balance | Balance | Balance | Balance |

| | | | Example | | |
|---|---|---|---|---|---|
| Component and product name | | | 5 | 6 | 7 |
| Solvent | 1,2-hexanediol | | 10 | 5 | 15 |
| | 1,2-propane diol | | 10 | 17 | 3 |
| | 1,2-butane diol | | | | |
| | 1,3-butane diol | | | | |
| Black | Black pigment | | 15 | 15 | 15 |
| pigment | dispersion | | | | |
| dispersion | (Pigment solids | | | | |
| | content: 20 | | | | |
| | percent by mass) | | | | |
| Surfactant | Polyethylene glycol | HW-1000 | 1 | 0.5 | 0.5 |
| | trimethylnonyl ether | TMN-10 | | | |
| | Acetylene glycol- | Surfynol 440 | | | |
| | based | | | | |
| | Polysiloxane-based | BYK-345 | | | |
| Resin | Urethane resin | WS-6021 | 8 | 8 | 8 |
| particle | | SUPERFLEX ® | | | |
| | | 460S | | | |
| | Acrylic resin | VONCOAT | 5 | 5 | 5 |
| | | 400 | | | |
| | | TOCRYL ™ | | | |
| | | W463 | | | |
| Water | Distilled water | | Balance | Balance | Balance |
| | | | Example | | |
| Component and product name | | | 8 | 9 | 10 |
| Solvent | 1,2-hexanediol | | 10 | 10 | 10 |
| | 1,2-propane diol | | 10 | 10 | 10 |
| | 1,2-butanediol | | | | |
| | 1,3-butane diol | | | | |
| Black | Black pigment | | 15 | 15 | 15 |
| pigment | dispersion | | | | |
| dispersion | (Pigment solids | | | | |
| | content: 20 | | | | |
| | percent by mass) | | | | |
| Surfactant | Polyethylene glycol | HW-1000 | 0.5 | 0.5 | |
| | trimethylnonyl ether | TMN-10 | | | 0.5 |
| | Acetylene glycol- | Surfynol 440 | | | |
| | based | | | | |
| | Polysiloxane-based | BYK-345 | | | |
| Resin | Urethane resin | WS-6021 | | | 8 |
| particle | | SUPERFLEX ® | 6 | 6 | |
| | | 460S | | | |
| | Acrylic resin | VONCOAT | 5 | | 5 |
| | | 400 | | | |
| | | TOCRYL ™ | | 6 | |
| | | W463 | | | |
| Water | Distilled water | | Balance | Balance | Balance |

| | | | Comparative | |
|---|---|---|---|---|
| | | | Example | |
| Component and product name | | | 1 | 2 |
| Solvent | 1,2-hexanediol | | | |
| | 1,2-propane diol | | | |
| | 1,2-butane diol | | 20 | |
| | 1,3-butane diol | | | 20 |
| Black | Black pigment | | 15 | 15 |
| pigment | dispersion | | | |
| dispersion | (Piment solids | | | |
| | content: 20 | | | |
| | percent by mass) | | | |
| Surfactant | Polyethylene glycol | HW-1000 | 0.5 | 0.5 |
| | trimethylnonyl ether | TMN-10 | | |
| | Acetylene glycol- | Surfynol 440 | | |
| | based | | | |
| | Polysiloxane-based | BYK-345 | | |
| Resin | Urethane resin | WS-6021 | 8 | 8 |
| particle | | SUPERELEX ® | | |
| | | 460S | | |
| | Acrylic resin | VONCOAT | 5 | 5 |
| | | 400 | | |
| | | TOCRYL ™ | | |
| | | W463 | | |
| Water | Distilled water | | Balance | Balance |
| | | | Comparative | |
| | | | Example | |
| Component and product name | | | 3 | 4 |
| Solvent | 1,2-hexanediol | | 10 | 10 |
| | 1,2-propane diol | | 10 | 10 |
| | 1,2-butane diol | | | |
| | 1,3-butane diol | | | |
| Black | Black pigment | | | |
| pigment | dispersion | | | |
| dispersion | Pigment solids | | 15 | 15 |
| | content: 20 | | | |
| | percent by mass) | | | |
| Surfactant | Polyethylene glycol | HW-1000 | | |
| | trimethylnonyl ether | TMN -10 | | |
| | Acetylene glycol- | Surfynol 440 | 1 | |
| | based | | | |
| | Polysiloxane-based | BYK-345 | | 1 |
| Resin | Urethane resin | WS-6021 | 8 | 8 |
| particle | | SUPERFLEX ® | | |
| | | 460S | | |
| | Acrylic resin | VONCOAT | 5 | 5 |
| | | 400 | | |
| | | TOCRYL ™ | | |
| | | W463 | | |
| Water | Distilled water | | Balance | Balance |

Materials Used for Ink

TRITON HW-1000 (polyethylene glycol trimethylnonyl ether, manufactured by Dow Chemical Japan Limited) was used as the polyoxyethylene ether compound.

As the other surfactants, Surfynol 440 (acetylene glycol-based surfactant, manufactured by Nissin Chemical co., ltd.) and BYK-345 (polysiloxane-based surfactant, manufactured by BYK) were used.

As the urethane resin particle, TAKELAC™ WS-6021 (solid content of 30.0 percent by mass, manufactured by Mitsui Chemicals, Inc.) or SUPERFLEX® 460S (solid content of 38 percent by mass, manufactured by DKS Co., Ltd.) was used.

As the acrylic resin particle, VONCOAT 400 (solid content of 38.0 percent by mass, manufactured by DIC Corporation) or TOCRYL™ W463 (solid content of 45 percent by mass, manufactured by TOYOCHEM CO., LTD.) was used.

The values of the pigment dispersion and resin particles shown in Table 1 correspond to those of solid contents.

The processing fluid was obtained by the following procedure.

A total of 10 parts of magnesium sulfate (manufactured by Naikai Salt Industries Co., Ltd.) was gradually added to 70 parts of pure water and 20 parts of 1,2-propane diol contained in a beaker. After all was dissolved, the solution obtained was stirred for 30 minutes followed by filtering with a filter to obtain a processing fluid.

Evaluation Method

The printing device illustrated in FIG. 3 was filled with the ink obtained. Black ink was discharged to a recording medium to print 3 cm square solid images at five places thereon followed by drying in an air oven at 70 degrees C. sufficiently.

The following was used as the recording media.
Plain paper: MyPaper (manufactured by Ricoh Company Ltd.)
Gloss paper: OK-TOP, manufactured by OJI PAPER CO., LTD.
PET: Lumirror T60 (thickness of 25 μm), manufactured by Toray Industries, Inc.

The processing fluid was applied by a roller to the recording medium shown in Table 2 at 10 g/m². Subsequent to drying, the printing device illustrated in FIG. 3 discharged the ink to the region where the processing fluid had been applied under the conditions above.

The solid image obtained was visually checked to evaluate the beading based on the following evaluation criteria.

The grade 3 or higher is allowable for practical purpose.

Evaluation Criteria

5: No beading
4: Slight beading causing no practical problem
3: Beading causing no practical problem
2: Apparent beading causing practical problem
1: Severe beading causing practical problem

Next, using cotton cloth (Kanakin No. 3), the solid image was rubbed under a load of 400 g 50 or more times. The solid image after the rubbing was visually checked to evaluate the abrasion resistance based on the following evaluation criteria. The grade 4 or higher is allowable for practical purpose.

Evaluation Criteria

5: No scratches after rubbing 50+ times
4: Slight scratches present after rubbing 50 times without affecting image luminosity (clarity), causing no practical problem
3: Scratches present after rubbing 50 times, lightly degrading image luminosity (clarity), causing practical problem
2: Scratches present after rubbing 20 to less than 50 times, degrading image luminosity (clarity), causing practical problem
1: Scratches present after rubbing less than 20 times, degrading image luminosity (clarity), causing practical problem

An A4 size solid image was continuously printed on a hundred sheets of gloss paper in “Beautiful Mode” by an ink-jet printer (iPSiO GXe 55(0), manufactured by Ricoh Co., Ltd.) and the printed images were visually checked to evaluate the discharging stability according to the following evaluation criteria

Evaluation Criteria

A: Image unchanged for all the hundred sheets
B: Streaks or unevenness occur between 50th and 100th sheet
C: Streaks or unevenness occur before 50th sheet

Grade A or B is allowable for practical purpose.

The evaluation results are shown in Table 2.

TABLE 2

| Evaluation | Recording | Processing | Example | | | | | | | | | |
|---|---|---|---|---|---|---|---|---|---|---|---|---|
| item | medium | fluid | 1 | 2 | 3 | 4 | 5 | 6 | 7 | 8 | 9 | 10 |
| Beading | Plain paper | None | 5 | 5 | 5 | 5 | 5 | 5 | 5 | 5 | 5 | 5 |
| | Coated paper | None | 5 | 5 | 5 | 5 | 5 | 5 | 5 | 5 | 5 | 5 |
| | (OK-TOP) | | | | | | | | | | | |
| | Coated paper | Yes | 5 | 5 | 5 | 5 | 5 | 5 | 5 | 5 | 5 | 5 |
| | (OK-TOP) | | | | | | | | | | | |
| | PET | None | 5 | 5 | 5 | 5 | 5 | 5 | 5 | 5 | 5 | 5 |
| | PET | Yes | 5 | 5 | 5 | 5 | 5 | 5 | 5 | 5 | 5 | 5 |
| Abrasion | Plain paper | None | 3 | 5 | 5 | 5 | 5 | 5 | 5 | 5 | 5 | 5 |
| resistance | Coated paper | None | 2 | 4 | 4 | 5 | 5 | 5 | 5 | 5 | 5 | 5 |
| | (OK-TOP) | | | | | | | | | | | |
| | Coated paper | Yes | 3 | 5 | 4 | 5 | 5 | 5 | 5 | 5 | 5 | 5 |
| | (OK-TOP) | | | | | | | | | | | |
| | PET | None | 2 | 4 | 4 | 5 | 5 | 5 | 5 | 5 | 5 | 5 |
| | PET | Yes | 3 | 5 | 4 | 5 | 5 | 5 | 5 | 5 | 5 | 5 |
| Discharging | — | — | A | B | A | A | A | A | A | A | A | A |
| stability | | | | | | | | | | | | |

| | | | Comparative | | | |
|---|---|---|---|---|---|---|
| Evaluation | Recording | Processing | Example | | | |
| item | medium | fluid | 1 | 2 | 3 | 4 |
| Beading | Plain paper | None | 4 | 4 | 4 | 4 |
| | Coated paper | None | 2 | 2 | 3 | 3 |
| | (OK-TOP) | | | | | |
| | Coated paper | Yes | 3 | 3 | 4 | 4 |
| | (OK-TOP) | | | | | |
| | PET | None | 2 | 2 | 3 | 3 |
| | PET | Yes | 3 | 3 | 4 | 4 |
| Abrasion | Plain paper | None | 5 | 5 | 5 | 5 |
| resistance | Coated paper | None | 5 | 5 | 5 | 5 |
| | (OK-TOP) | | | | | |
| | Coated paper | Yes | 5 | 5 | 5 | 5 |
| | (OK-TOP) | | | | | |
| | PET | None | 5 | 5 | 5 | 5 |
| | PET | Yes | 5 | 5 | 5 | 5 |
| Discharging | — | — | B | B | C | C |
| stability | | | | | | |

As seen in the results of Examples and Comparative Examples, the ink and image forming method are excellent regarding beading, abrasion resistance, and discharging stability.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An ink comprising:
organic solvents comprising 1,2-propane diol and 1,2-hexane diol,
a pigment;
water; and
a polyoxyethylene ether compound.

2. The ink according to claim 1, further comprising at least one of a urethane resin or an acrylic resin.

3. The ink according to claim 2, wherein the at least one of the urethane resin or the acrylic resin are resin particles.

4. An image forming method comprising:
applying a processing fluid containing a flocculant to a recording medium; and
inkjetting the ink of claim 1 to the recording medium on which the processing fluid has been applied to form an image.
